(19) United States
(12) Patent Application Publication
(10) Pub. No.: US 2012/0282077 A1
(43) Pub. Date: Nov. 8, 2012

(54) Automated Refuse Vehicle Packing System

(75) Inventors: Weston W. Alberts, Kasson, MN (US); Jeffrey E. Baumberger, Hartford, WI (US); William R. Schmidt, Rochester, MN (US)

(73) Assignee: McNeilus Truck and Manufacturing, Inc., Dodge Center, MN (US)

(21) Appl. No.: 13/462,992

(22) Filed: May 3, 2012

Related U.S. Application Data
(60) Provisional application No. 61/482,062, filed on May 3, 2011.

(51) Int. Cl. B65F 3/20; B65F 3/04

(52) U.S. Cl. 414/810

(57) ABSTRACT

A method of controlling the deposition and packing of refuse in a refuse vehicle body that includes a container handling lift and dump mechanism that automatically grasps, lifts and dumps refuse containers into a charging hopper and a packer panel and attached follower panel operable in the charging hopper, the method comprising causing the container handling lift and dump mechanism to pause before dumping a container in a lift and dump cycle until the packer panel is fully retracted.

### CROSS-REFERENCED TO RELATED APPLICATIONS

This application is a non-provisional application of Application No. 61/482,062, filed May 3, 2011 and claims priority from that application which is also deemed incorporated by reference in its entirety in this application.

### STATEMENT REGARDING FEDERALLY SPONSORED RESEARCH OR DEVELOPMENT

Not applicable

### BACKGROUND OF THE INVENTION

I. Field of the Invention

The present invention relates generally to refuse collecting vehicles and, particularly, to any, rear-discharging refuse vehicle having a packing panel system which utilizes a follower panel and a wiper member such that it can accommodate deposition of refuse with the system in any position of a packing cycle. The packing system, which includes a packing panel with connected follower, is provided with an automated system to cause the packer to be in the fully retracted or home position before a refuse container can be tipped into the receiving hopper. Particular applications include front and side loading vehicles.

II. Related Art

Refuse hauling vehicles commonly include a heavy-duty chassis including a forward cab and a separately manufactured truck body mounted on the chassis and dedicated to receiving, compacting, hauling and discharging refuse materials. The truck body which attaches to the chassis generally includes all the associated hydraulic, pneumatic and/or electrical operating mechanisms associated with heavy-duty packing and ejection equipment. In front or side-loading systems, a charging or receiving hopper or section is provided behind the cab and forward of the storage volume to accept deposited refuse. The receiving section further contains a packing system for packing deposited refuse rearward into a storage enclosure. As indicated, the receiving area or section is located behind the truck cab and refuse to be hauled is loaded into the receiving area as by tipping containers, either manually, with a cart tipper or other mechanized container handling system which, in the case of a side-loading vehicle, is mounted on one side of the charging hopper or to the truck chassis. Thus, loading of the charging area is accomplished through side openings or an open top. The packing system includes a reciprocating or sometimes rotating ram, usually hydraulically operated, which compacts the material moving it rearward into the storage compartment where it is eventually compacted against a heavy-duty tailgate, normally in the shape of a pressure vessel.

It is known to provide a front, rear or side-loading refuse vehicle body with a packing and ejecting mechanism that packs refuse from a charging area or section into an associated hollow storage enclosure. The body is usually designed to be tipped to fully eject the refuse from the storage enclosure, but it may have an ejector design that enables it to fully eject refuse without tipping. In front loading vehicles, it is known to provide frontal forks or a mechanized lifting and emptying apparatus situated on one side of the receiving hopper such that a container of interest may be engaged and emptied into the receiving hopper. A side-loading apparatus typically includes a holding or grasping device generally connected to an arm or extensible boom which is connected, in turn, to a base mounted on the vehicle. The arm or boom and grasping device are operated in concert to engage a container of interest, lift and dump the container into the receiving hopper in the vehicle. Such systems are typically operated using one or more hydraulic devices to extend or retract the boom, pivot the arm and open and close the grabbing device.

Side loading refuse collection truck bodies may be manually loaded, have cart tipper or automatic loading devices, or combine or accommodate both manual and automated-type container loading abilities. Packer panel systems have also been provided with connected follower members that enable the loading of refuse to proceed with the packer panel in any position, including a fully extended packing position.

As indicated, the packing function on a side-loading refuse-collection vehicle is accomplished by a packing mechanism, which may be any of various shapes and sizes. The packing mechanism is made up of a packer panel, follower panel, and hydraulic cylinders. The follower panel is designed to prevent refuse from being deposited behind the packer panel and is attached to, and extends with, the packer panel. The follower panel holds a relatively steep angular position against the front wall of the receiving hopper when the packing mechanism is retracted (see FIG. 1). The angle of the follower panel position decreases constantly as the packing mechanism extends (see FIG. 2). The follower panel protects the hydraulic cylinders from refuse and keep refuse in the hopper and out of the cylinder compartment behind the packer panel if the packer panel is extended when refuse is dumped into the hopper.

When a conventional side-loading refuse-collection vehicle is operated, the packing mechanism is often extending at the same time the dumping mechanism is dumping refuse into the hopper. Because of this, refuse is frequently dumped onto the follower panel. Due to the relatively flat position of the follower panel when this happens, refuse dumped onto the follower panel is less likely to move off of the follower panel onto the hopper floor in front of the packer panel. Once refuse starts to collect on the follower panel, additional refuse dumped onto the follower after that is more likely to stay on the follower. This condition is known as “bridging”. When refuse remains on the follower instead of falling in front of the packer panel, it may build up until the volume of the hopper is significantly reduced by refuse that is not getting packed into the body. Bridging can be a significant cause of delays over the course of a day of operation. It has become a major challenge, particularly for a side-loading refuse-collection vehicle to get the refuse to consistently fall in front of the packing mechanism instead of on the follower.

### SUMMARY OF THE INVENTION

To accomplish the goal of getting the refuse to consistently fall in front of the packing mechanism instead of on the follower applicants have discovered a method of controlling the packer mechanism to maximize the potential for the packer to be retracted when the dumping mechanism dumps refuse into the hopper, reducing the opportunity for refuse to be dumped onto the follower.

The system uses a plurality of sensing and control devices. It is possible to detect when the dumping mechanism has reached a pre-determined point in the dumping cycle and ascertain whether the packer panel is in the retracted or “home” position at that time. Using the signal from a dump mechanism sensing device such as a proximity sensor and a logic system, and detecting that the packer panel is not in the retracted or home position, a master control causes the dumping cycle to pause and the packing mechanism to retract before the dumping cycle can be resumed and refuse can be dumped into the hopper. The closer the packing mechanism is to the fully retracted home position, the steeper the angular position of the follower panel, and with the packer panel fully retracted, refuse deposited on the panel will fall off the follower panel and be deposited in front of the packer panel.

A master control module is provided that controls both the operation of the packer system and the associated container dumping or loading system. Thus, through signals, the master module knows the location of the packer relative to the fully extended position or the fully retracted-home position. When input to the control module indicates that the arm or other mechanism of the container dumping mechanism is sensed by a proximity sensor to be in a container raising or arm up mode, a proximity switch or other interlock is provided that pauses the container handling cycle if the packer is anywhere except in the fully retracted-home position, as sensed by one or more other sensors. If necessary, a signal is sent to retract the packer to a sensed fully retracted-home position prior to resuming the cycle for loading or dumping of a refuse container. The position of an up ramp or other proximity switch or other sensor may also be set to allow enough time before a can or other container is dumped to retract the packer from the fully-extended position to the fully retracted-home position to ensure that the packer will always be fully retracted before the container can be dumped.

It should be noted that a proximity switch is one means of detecting the operation of the associated container dumping means, however, it is contemplated that any type of interlocking signal or mechanism can be used to signal the packer to retreat to the home position and delay the dumping of the container until this is accomplished.

The present development pertains to any refuse collection vehicle of a type using a packer panel that operates reciprocally along in the vehicle body with a connected follower panel. This includes both front and side loading vehicles.

### BRIEF DESCRIPTION OF THE DRAWINGS

In the drawings, wherein like reference characters denote like parts:

FIG. 1 is a schematic drawing showing a packer panel and a follower panel with the packer panel in the fully retracted-home position with the follower panel at the steepest angle;

FIG. 2 is a schematic drawing of the packer panel with follower panel of FIG. 1 showing the packer panel fully extended and the follower panel at a corresponding low angle;

FIGS. 3A-3D show a series of drawings of a side loading hopper and partial storage compartment with parts removed to better illustrate a sequence of loading in accordance with the invention;

FIG. 4 is a flow chart of a control system in accordance with the invention; and

FIG. 5 is a schematic perspective view of a refuse hauling vehicle with a manual/automated side loading, rear discharging packer body shown with tailgate removed.

### DETAILED DESCRIPTION

The detailed description features an embodiment applicable to a manual/automated side-loading, or front-loading rear-discharging refuse collection vehicle. The embodiment is meant as an example only and is not intended to limit the scope of the inventive concepts in any manner.

The front or side-loading refuse collection vehicle bodies include a refuse packing system having a low profile packer panel designed to operate reciprocally along the vehicle body charging area to push deposited refuse rearward and include a packer panel and hinged follower panel.

The present invention keeps the hopper from “bridging”, allowing the operator to continue working the system instead of the current process of stopping every X number of route stops to assert the packer to remove bridged material. This will reduce route time for each sideloader, for example, the cumulative effect of which will be to reduce the number of automated sideloader's needed.

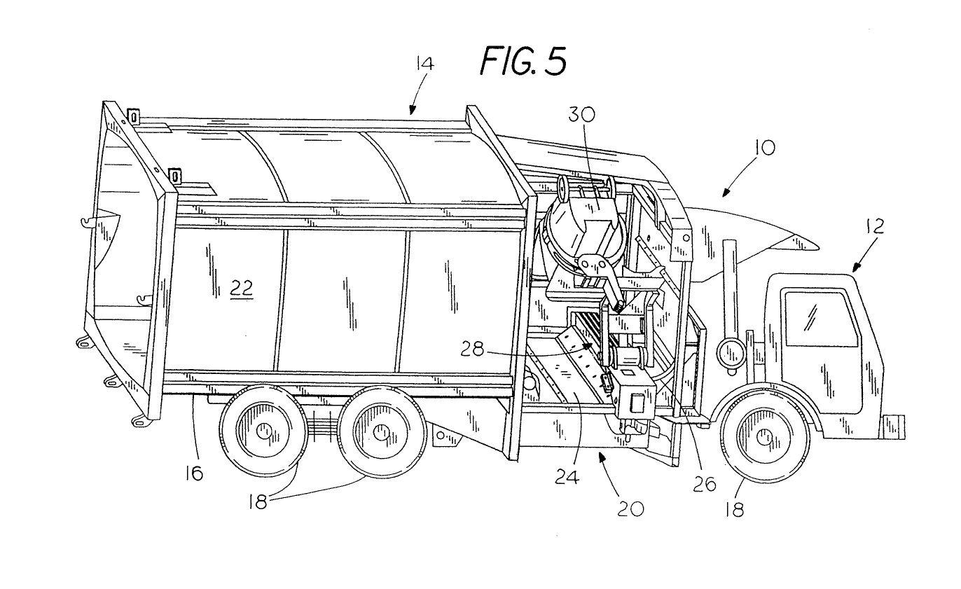

In FIG. 5, there is shown a schematic perspective view of a refuse hauling vehicle, generally at 10, which includes a chassis-mounted cab 12 and a dedicated refuse processing body 14 shown with the tailgate removed. The packer body is mounted on heavy chassis members as at 16 and is carried by a plurality of wheels as at 18. The truck body basically includes a charging or receiving area indicated generally by 20 and a relatively large storage area at 22. In the view illustrated in FIG. 1, the tailgate has been removed showing a portion of the interior of the storage volume 22. A packer panel is shown at 24 in a forward position and a follower is shown at 24. A laterally extending container handling system is shown at 28 emptying a container 30. The vehicle is one suitable for adding the automated system of the present invention.

Whereas FIG. 5 illustrates a side loading vehicle, the system of the invention works just as well with a conventional front loading rear discharge refuse packing truck body.

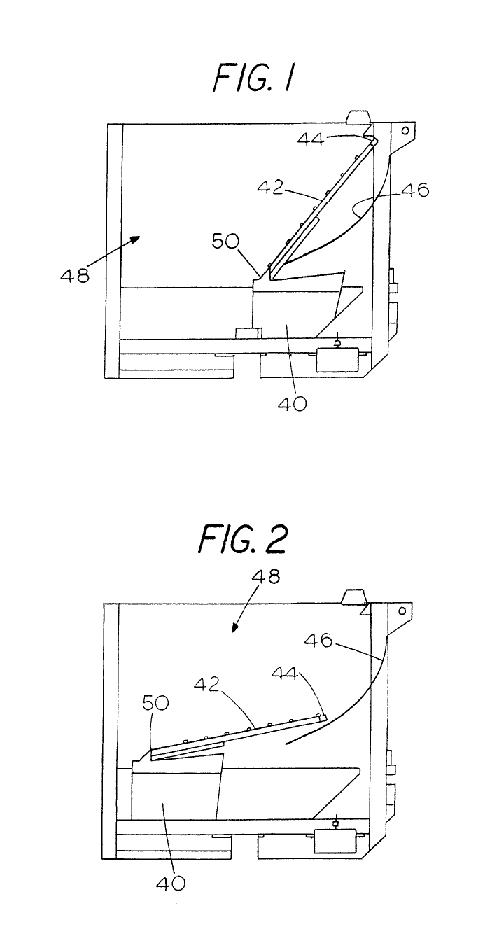

FIGS. 1 and 2 are schematic drawings showing the relationship between a typical packer panel 40 and a follower panel 42. The follower panel includes wheels 44 to contact and ride along a curved front panel 46 of a hopper area 48 and is hinged to the packer panel at 50. The packer panel 40 is shown fully retracted, or in the home position, in FIG. 1 with the follower panel at its highest angle, and is shown fully forward in the packing position in FIG. 2 with the follower in at its lowest angle.

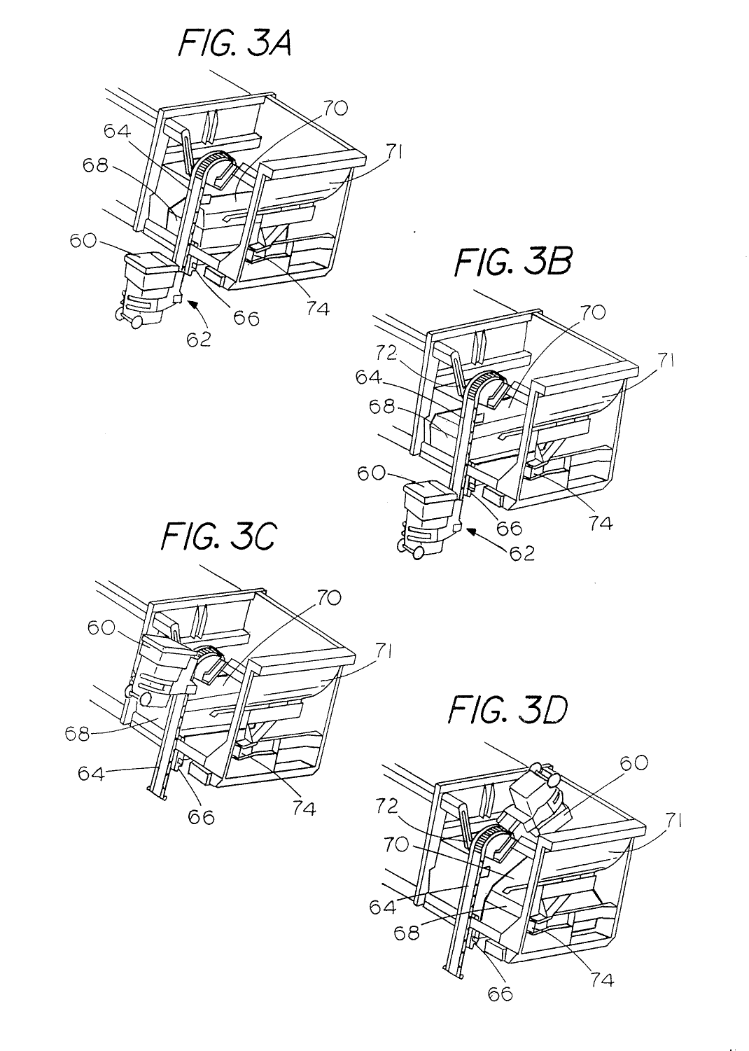

FIGS. 3A-3D show a sequence of loading using a conventional curb side container in conjunction with a side loading refuse body. The loading sequence starts with a container 60 grasped by a container handling and dumping mechanism 62 which operates along an up ramp 64 to lift and dump a grasped container. The bottom part of the up ramp is attached to an extendable arm 66. In FIG. 1, the container handling and dumping mechanism 62 is in the fully down position and the packer panel 68 fully extended. The packer panel 68 is shown with follower panel 70 with curved front panel 71. An up-ramp proximity switch denoted by 72 is located in the vicinity of the top portion of the up ramp and a packer panel home proximity switch is shown at 74.

It will be appreciated that the term “proximity switch” includes both devices that combine the sensing element with the signal-conditioning electronics in those devices that do not include such a combination. In addition, because the proximity switches sense the relative motion between the switch and the item of interest, the proximity switch may be stationary or may be located on the moving device. Thus, the location of a device may be accomplished either way.

In FIG. 3B, the grasping and loading device 62 begins to raise or lift the container with the packer still fully extended. In FIG. 3C, the up-ramp proximity sensor of the invention is tripped causing the packer to retract while the container handling and dumping mechanism awaits the system to time out the time required for the packer to fully retract. The packer panel home proximity switch confirms the retraction. Thereafter, as shown in FIG. 3D, the container is dumped with the packer fully retracted and the follower panel in the fully raised position.

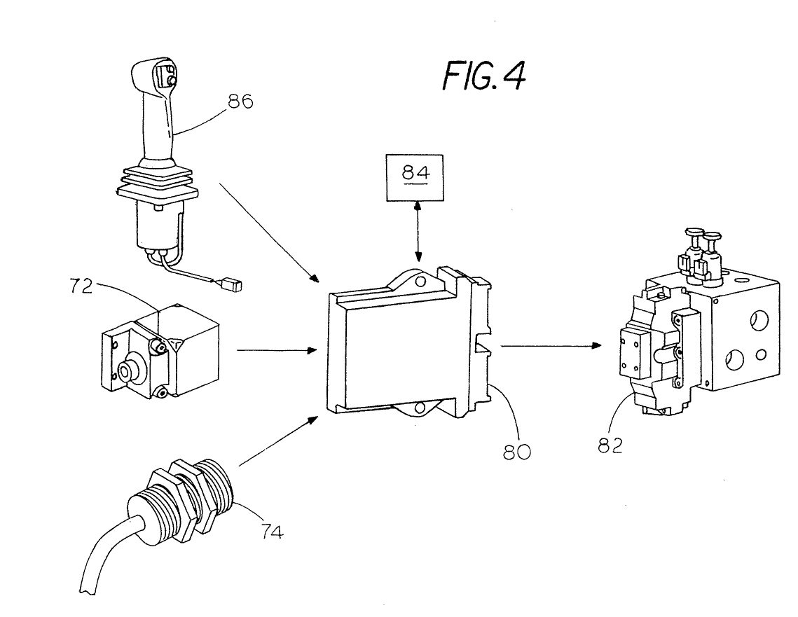

FIG. 4 is a diagram showing a possible control scheme for the automated packing sequence system of the invention. The system includes a master control module 80 which includes all the necessary data processing and signaling devices necessary to coordinate the system. A hydraulic valve device for operating the packer panel is shown at 82 and a container handling and dumping mechanism control is shown at 84. The entire sequence of operation can be automatic and initiated from the cab of the associated refuse vehicle using a joy stick 86 and the control system may be wired or wireless. A signal from the joy stick initiates the lift and dump sequence. When the container nears the top of the ramp, the up-ramp proximity switch 72 signals the master control module 80 to retract the packer panel while the up-ramp proximity switch times out. The timing circuit includes an interval sufficient for the packer panel to fully retract to the home position from a fully extended state. The master control module then allows the dump cycle to be completed. Alternatively, if the packer panel home proximity switch signals that the packer panel is in the home position, this may be used to allow the dump cycle to be completed. This may be used to override the up-ramp proximity switch timing circuit.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

1. A method of controlling the deposition and packing of refuse in a refuse vehicle body that includes a container handling lift and dump mechanism that automatically grasps, lifts and dumps refuse containers into a charging hopper and a packer panel and attached follower panel operable in said charging hopper, the method comprising
causing said container handling lift and dump mechanism to pause before dumping a container in a lift and dump cycle until said packer panel is fully retracted, if necessary, causing said packer panel to retract at the beginning of said pause.

2. A method as in claim 1 wherein the length of said pause is controlled by a timer that provides sufficient time for said packer panel to move from fully extended position to a fully retracted position.

3. A method as in claim 1 wherein said pause is initialed by a proximity sensor associated with said container handling lift and dump mechanism.

4. A method as in claim 1 wherein the packer panel is sensed as being in the fully retracted position by a proximity switch.

5. A method as in claim 3 wherein said proximity sensor is a proximity switch device.
